(19) United States
(12) Patent Application Publication
(10) Pub. No.: US 2013/0063562 A1
(43) Pub. Date: Mar. 14, 2013

(54) METHOD AND APPARATUS FOR OBTAINING GEOMETRY INFORMATION, LIGHTING INFORMATION AND MATERIAL INFORMATION IN IMAGE MODELING SYSTEM

(71) Applicants: Hyun Jung SHIM, Seoul (KR); Do Kyoon Kim, Seongnam-si (KR); Seung Kyu Lee, Seoul (KR)

(72) Inventors: Hyun Jung SHIM, Seoul (KR); Do Kyoon Kim, Seongnam-si (KR); Seung Kyu Lee, Seoul (KR)

(73) Assignee: SAMSUNG ELECTRONICS CO., LTD., Suwon-si (KR)

(21) Appl. No.: 13/443,158

(22) Filed: Apr. 10, 2012

(30) Foreign Application Priority Data
Sep. 9, 2011 (JP) 10-2011-0091874

(51) Int. Cl. H04N 13/02; H04N 7/18

(52) U.S. Cl. 348/46; 348/135; 348/E07.085; 348/E13.074

(57) ABSTRACT

A method and apparatus for obtaining geometry information, material information, and lighting information in an image modeling system are provided. Geometry information, material information, and lighting information of an object may be extracted from a single-view image captured in a predetermined light condition, by applying pixel values defined by a geometry function, a material function, and a lighting function.

### CROSS-REFERENCE TO RELATED APPLICATIONS

This application claims the benefit of Korean Patent Application No. 10-2011-0091874, filed on Sep. 9, 2011, in the Korean Intellectual Property Office, the disclosure of which is incorporated herein by reference.

### BACKGROUND

1. Field

One or more example embodiments of the following description relate to a method and apparatus for obtaining geometry information, material information, and lighting information in an image modeling system.

2. Description of the Related Art

With the development of three-dimensional (3D) graphics technology and 3D graphics-related hardware technology, content is formed to realistically express an object in various application fields, for example 3D games, 3D movies, smartphones, and the like. To realistically express an object, a rendering technology may be used. The rendering technology requires accurately modeling geometry, properties of material, and lighting.

Information on materials or properties of materials may be obtained by capturing an object within a restricted space using additional equipment. However, in this instance, it is difficult to apply the additional equipment to various environments, and users may not easily secure content.

To perform modeling on light or lighting, an omnidirectional lighting environment map may be used. However, to extract the lighting environment map, a special auxiliary apparatus is required. Accordingly, modeling of a dynamic lighting environment may be limited.

To generate a real 3D image, image information of an object to be represented through a 3D display may be obtained by repeatedly capturing the object at infinitely many viewpoints. However, there is a limitation in directly capturing the object at an infinite number of viewpoints.

### SUMMARY

The foregoing and/or other aspects are achieved by providing an apparatus for obtaining geometry information, the apparatus including a processor to control one or more processor-executable units, an optical image receiving unit to receive an image of an object receiving a plurality of pattern lights, a frequency verifying unit to verify, from the image, a plurality of frequency bands respectively corresponding to each of the plurality of pattern lights, a code set assigning unit to assign a plurality of code values based on at least one reflected light corresponding to each of the plurality of frequency bands, the plurality of code values being used to distinguish surface points of the object, and a surface point acquiring unit to distinguish the surface points of the object based on the plurality of code values.

The foregoing and/or other aspects are achieved by providing a system for obtaining geometry information, the system including a light emitting unit to emit a plurality of pattern lights to an object, each of the plurality of pattern lights being respectively assigned to a plurality of frequency bands, a camera unit to capture the object receiving the pattern lights emitted from the light emitting unit, and a geometry information obtaining unit to assign a plurality of code values based on at least one reflected light corresponding to each of the pattern lights, to distinguish surface points of the object based on the plurality of code values, and to obtain geometry information of the object using the surface points, the plurality of code values being used to distinguish the surface points.

The foregoing and/or other aspects are achieved by providing an apparatus for obtaining material information and lighting information in an image modeling system, the apparatus including a processor to control one or more processor-executable units, an optical image receiving unit to receive an image of an object, the object receiving at least one of pattern lights, a straight light, and a natural light, the pattern lights being emitted from a first lighting emitting unit, and the straight light being emitted from a second lighting emitting unit, and a computation unit to compute at least one of a material function and a lighting function, using pixel values of pixels of the image received by the optical image receiving unit, the pixel values being defined by a material function, an emitted lighting function, and a natural lighting function.

The foregoing and/or other aspects are achieved by providing a system for obtaining material information and lighting information, the system including a first light emitting unit to emit a plurality of pattern lights to an object, the plurality of pattern lights being respectively assigned to a plurality of frequency bands, a second light emitting unit to emit a straight light to the object, the straight light being assigned to a frequency band other than the plurality of frequency bands, a camera unit to capture an image of the object receiving lights emitted from the first light emitting unit and the second light emitting unit, or to capture an image of the object receiving a natural light other than the lights emitted from the first light emitting unit and the second light emitting unit, and a computation unit to compute at least one of a material function, emitted lighting functions, and a natural lighting function, based on the captured images.

The foregoing and/or other aspects are achieved by providing a method of obtaining geometry information in an image modeling system, the method including receiving an image of an object receiving a plurality of pattern lights, verifying, from the image, a plurality of frequency bands respectively corresponding to the plurality of pattern lights, assigning a plurality of code values based on at least one reflected light corresponding to each of the plurality of frequency bands, the plurality of code values being used to distinguish surface points of the object, and distinguishing the surface points of the object based on the plurality of code values.

The foregoing and/or other aspects are achieved by providing a method of obtaining material information and lighting information in an image modeling system, the method including receiving an image of an object, the object receiving at least one of pattern lights, a straight light, and a natural light, the pattern lights being emitted from a first lighting emitting unit, and the straight light being emitted from a second lighting emitting unit, and computing, by way of a processor, at least one of a material function, an emitted lighting function, and a natural lighting function, based on the received image.

The foregoing and/or other aspects are achieved by providing a method of obtaining material and lighting information. The method includes receiving an image of an object, the object receiving at least one of pattern lights, a straight light, and a natural light, the pattern lights being emitted from a first lighting emitting unit, and the straight light being emitted from a second lighting emitting unit and computing, by way of a processor, at least one of a material function, an emitted lighting function, and a natural lighting function, based on the received image.

The foregoing and/or other aspects are achieved by providing a method of obtaining material information. The method includes receiving an image of an object, the object receiving at least one of pattern lights, a straight light, and a natural light, the pattern lights being emitted from a first lighting emitting unit, and the straight light being emitted from a second lighting emitting unit, and computing, by way of a processor, a material function, using pixel values of pixels of the received image, the pixel values being defined by a material function, an emitted lighting function, and a natural lighting function. The computing further includes computing emitted lighting functions, using a difference between a pixel value iₐ of an image of an object that receives a plurality of pattern lights and a pixel value i_{c} of an image of an object that receives a natural light, and a difference between the pixel value i_{c} and a pixel value i_{b} of an image of an object that receives a straight light and computing the material function, using the computed emitted lighting functions.

The foregoing and/or other aspects are achieved by providing an apparatus obtaining geometry information. The apparatus includes a processor to control one or more processor-executable units, an optical image receiving unit to receive an image of an object illuminated by a plurality of pattern lights emitted by a plurality of light emitting units, a frequency verifying unit to verify, from the image, a plurality of frequency bands respectively corresponding to each of the plurality of pattern lights, and a code set assigning unit to assign a plurality of code values based on at least one reflected light corresponding to each of the plurality of frequency bands, the plurality of code values being used to distinguish surface points of the object.

The foregoing and/or other aspects are achieved by providing a method of obtaining geometry information. The method includes receiving an image of an object illuminated by a plurality of pattern lights, wherein a different pattern light is respectively assigned to each of a plurality frequency bands, verifying, from the image, the pattern lights respectively assigned to the frequency bands and classifying the frequency bands based on the pattern lights, and assigning, by way of a processor, a plurality of code values based on at least one reflected light corresponding to each of the plurality of frequency bands, the plurality of code values being used to distinguish surface points of the object.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a diagram of an image capturing scheme to obtain geometry information according to example embodiments;

FIG. 2 illustrates a diagram of a light bandwidth based on frequency bands;

FIG. 3 illustrates a block diagram of a geometry information obtaining apparatus according to example embodiments;

FIG. 4 illustrates a diagram of an example of frequency analysis to obtain geometry information according to example embodiments;

FIG. 5 illustrates a flowchart of a method of obtaining geometry information according to example embodiments;

FIGS. 6A, 6B, and 6C illustrate diagrams of examples of obtaining material information and lighting information according to example embodiments;

FIG. 7 illustrates a block diagram of an apparatus for obtaining material information and lighting information according to example embodiments;

FIG. 8 illustrates a flowchart of a method of obtaining material information and lighting information according to example embodiments; and

FIGS. 9A and 9B illustrate diagrams of an image capturing scheme according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

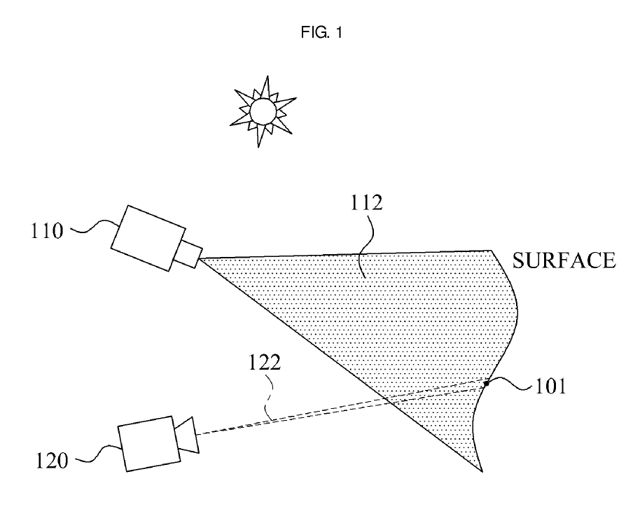

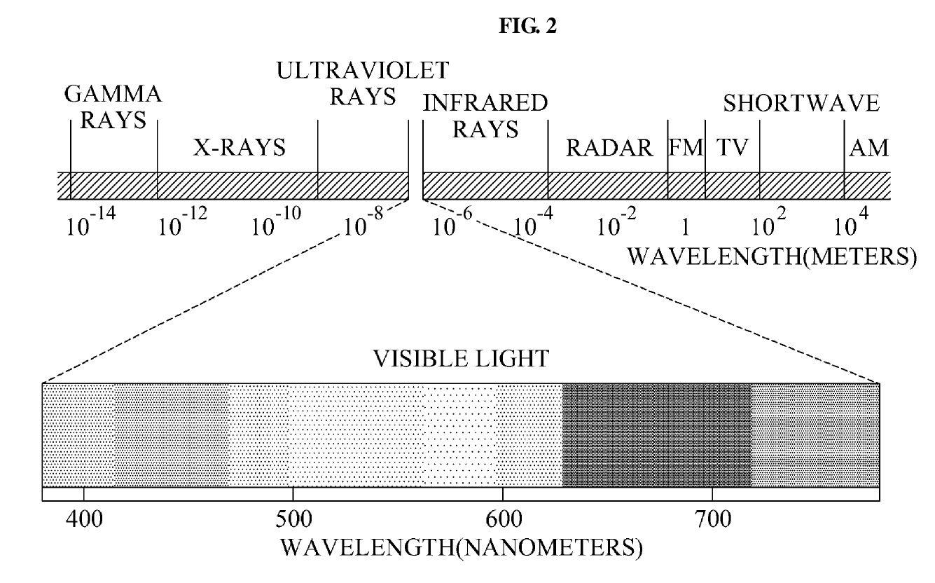

FIG. 1 illustrates a diagram of an image capturing scheme to obtain geometry information according to example embodiments, and FIG. 2 illustrates a diagram of a light bandwidth based on frequency bands.

Referring to FIG. 1, a light emitting unit 110, and a camera unit 120 are used to obtain geometry information.

The light emitting unit 110 may be, for example, a multi-spectral projector. Additionally, the camera unit 120 may be, for example, a multi-spectral camera.

The light emitting unit 110 may emit rays in frequency bands of a visible region and an infrared region in which radioactivity does not exist, among all frequency bands. The light emitting unit 110 may use X-rays, or gamma (γ) rays that have transparency of radioactive particles. Accordingly, geometry information regarding internal organs may be obtained.

The light emitting unit 110 may classify a frequency band enabling emitting of light toward an object into N frequency bands, and may respectively assign different pattern lights to the N frequency bands. The light emitting unit 110 may emit the assigned pattern lights to a surface 101 of an object. The pattern lights assigned to the N frequency bands may be simultaneously emitted toward the object. In the present specification, a method of obtaining geometry information will be described based on a gray coded pattern light. However, the geometry information may be obtained using sinusoidal pattern light, grid pattern light, a De Bruijn sequence, and the like, instead of or in addition to using the gray coded pattern light.

The camera unit 120 may photograph or capture a pattern light 112 emitted toward the object by the light emitting unit 110. Specifically, the camera unit 120 may capture the surface 101 of the object that receives the emitted pattern light 112.

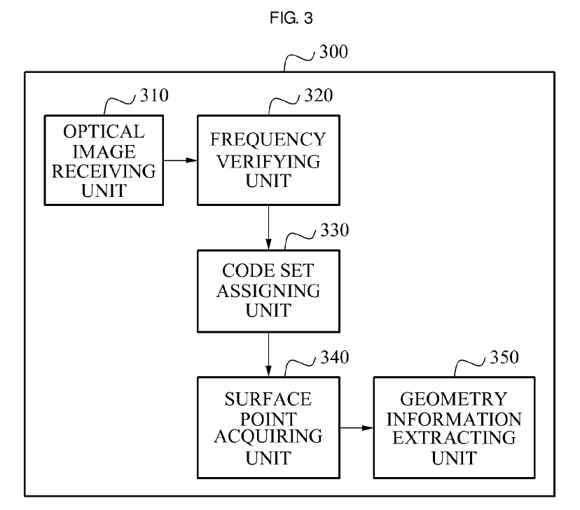

The camera unit 120 may transmit an image obtained by capturing the surface 101 to a geometry information obtaining apparatus 300 of FIG. 3.

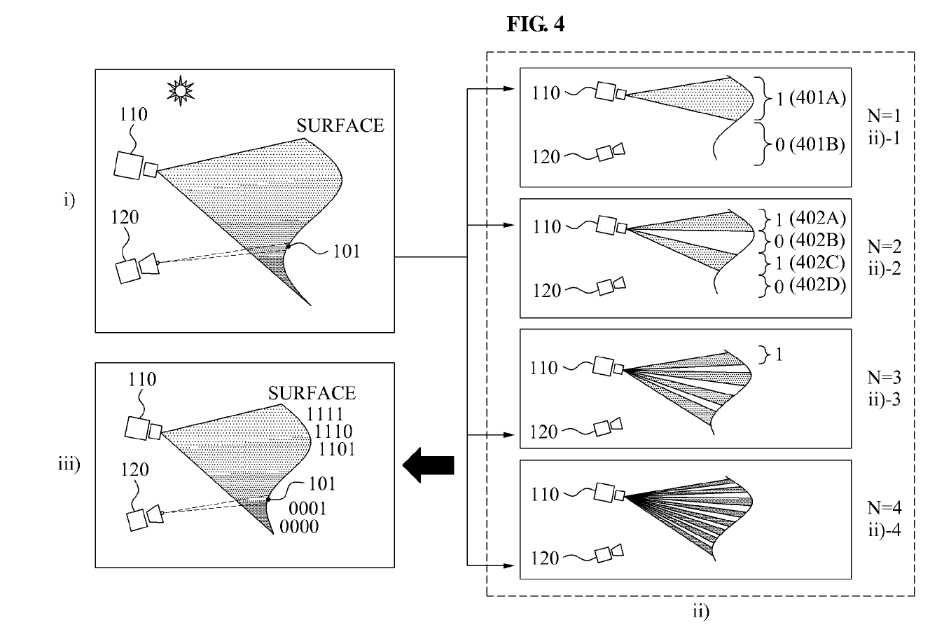

FIG. 3 illustrates a block diagram of the geometry information obtaining apparatus 300, and FIG. 4 illustrates a diagram of an example of frequency analysis to obtain geometry information according to one or more example embodiments.

Referring to FIG. 3, the geometry information obtaining apparatus 300 may include, for example, an optical image receiving unit 310, a frequency verifying unit 320, a code set assigning unit 330, a surface point acquiring unit 340, and a geometry information extracting unit 350.

The optical image receiving unit 310 may receive an image of an object upon which a plurality of pattern lights has been emitted. In other words, the object is illuminated by a plurality of pattern lights.

The frequency verifying unit 320 may verify a plurality of frequency bands from the image received by the optical image receiving unit 310. Each of the plurality of frequency bands may respectively correspond to one of the plurality of pattern lights. Additionally, the frequency verifying unit 320 may verify the pattern lights respectively assigned to the frequency bands, and may classify the frequency bands based on the pattern lights.

The code set assigning unit 330 may assign a plurality of code values, based on at least one reflected light corresponding to each of the plurality of frequency bands verified by the frequency verifying unit 320. The plurality of code values may be used to distinguish surface points of the object from other points. Specifically, the code set assigning unit 330 may assign a first code value to an area in which a reflected light exists, and may assign a second code value to an area in which the reflected light does not exist, every time a pattern light is emitted. The reflected light may refer to light reflected from the surface 101 of the object. In an example of the gray coded pattern light, when assignment of code values is repeated N times, 2^{N} surface points may be distinguished from other surface points. Referring to FIG. 4 i), a light emitting unit 110 may emit pattern lights upon the surface 101, and the pattern lights may be respectively assigned to a plurality of frequency bands. Additionally, the pattern lights may have different patterns for each of the frequency bands as shown in FIG. 4 ii). Here, lights reflected from the surface 101 of the object that receives the pattern lights may each have N code values.

For example, as shown in FIG. 4 ii), code values may be assigned based on each of the frequency bands. In FIG. 4 ii)-1, when N is equal to ‘1,’ a code value of ‘1’ or ‘0’ is assigned to a first frequency band. The code value may include a first code value, and a second code value, depending on whether the reflected light exists. Specifically, when the first code value of ‘1’ is assigned to an area 401 in which the reflected light exists, and when the second code value of ‘0’ is assigned to an area 402 in which the reflected light does not exist, ‘1’ and ‘0’ may be acquired from the first frequency band.

Additionally, in FIG. 4 ii)-2, when N is equal to ‘2,’ a code value is assigned to a second frequency band. The second frequency band may divide, by half, the assigned code value in the first frequency band. In other words, code values may be assigned to four areas 402A, 402B, 402C, and 402D in the second frequency band. For example, a code value of ‘0’ or ‘1’ may be assigned to each of the four areas 402A, 402B, 402C, and 402D, depending on whether the reflected light exists. In the second frequency band, two code values may exist and may each include a first code value and a second code value. When the first code value and the second code value are set to ‘1’ and ‘0,’ respectively, ‘1,’‘0,’‘1,’ and ‘0’ may be acquired from the second frequency band.

Similarly, FIGS. 4 ii)-3, and ii)-4 illustrate an example in which a code value is assigned to a third frequency band when N is equal to ‘3,’ and an example in which a code value is assigned to a fourth frequency band when N is equal to ‘4,’ respectively. Accordingly, ‘8’ code values may be acquired from the third frequency band, and ‘16’ code values may be acquired from the fourth frequency band, since a number of code values acquired from one or more frequency bands may correspond to 2^{N}.

The surface point acquiring unit 340 may distinguish surface points of the object, based on the code values assigned by the code set assigning unit 330. The surface point acquiring unit 340 may acquire code values from each of the first frequency band through the fourth frequency band, may combine the acquired code values, and may obtain surface point information regarding 2^{N} surface points of the object as shown in FIG. 4 iii).

FIG. 4 iii) illustrates an example of surface point information. The surface point information may include surface point values acquired by combining the code values acquired from each of the first frequency band through the fourth frequency band. For example, a surface point with surface point information of ‘1111’ may indicate an area that receives pattern lights corresponding to the first frequency band through the fourth frequency band. Additionally, a surface point with surface point information of ‘0000’ may indicate an area that does not receive any of the pattern lights corresponding to the first frequency band through the fourth frequency band.

The geometry information extracting unit 350 may obtain geometry information of the object, using pieces of surface point information acquired by the surface point acquiring unit 340. When a code set is assigned to the surface of the object by the code set assigning unit 330, the geometry information extracting unit 350 may enable the code set to correspond to a single surface point observed simultaneously from two apparatuses, for example a projector and a camera. Specifically, a position of a predetermined pixel of an image projected by the projector, and a position of a predetermined pixel of an image captured by the camera may correspond to each other at a corresponding point. Additionally, the geometry information extracting unit 350 may obtain an intersection point between a straight light connecting the corresponding point to a physical position of the camera and a straight light connecting the corresponding point to a physical position of the projector, and may determine a 3D position of the corresponding point. The physical position of the camera may include a three-dimensional (3D) position, and information determined in advance via calibration.

In the same manner as described above, 3D positions of all surface points in a surface of an object may be obtained, and accordingly geometry information may be obtained. The geometry information may be used for various geometry restoration technologies.

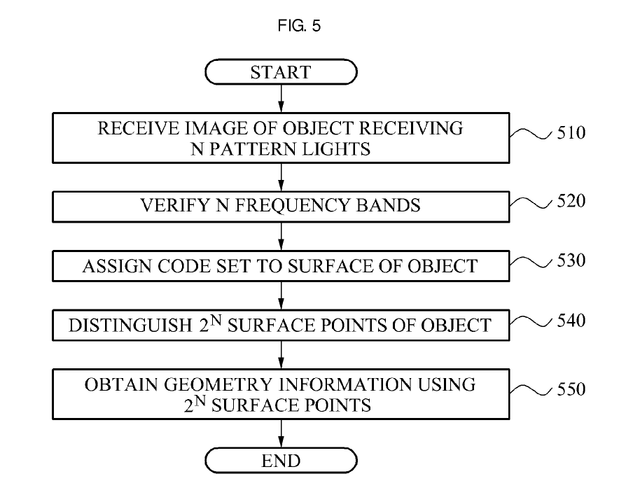

FIG. 5 illustrates a flowchart of a method of obtaining geometry information according to example embodiments.

The method of FIG. 5 may be performed by the geometry information obtaining apparatus 300 of FIG. 3.

Referring to FIG. 5, in operation 510, the geometry information obtaining apparatus 300 may receive an image of an object that receives N pattern lights. In this instance, N may be an integer greater than ‘2.’

In operation 520, the geometry information obtaining apparatus 300 may verify N frequency bands that respectively correspond to the N pattern lights.

In operation 530, the geometry information obtaining apparatus 300 may assign a code set to a surface of the object based on at least one reflected light corresponding to each of the N frequency bands.

In operation 540, the geometry information obtaining apparatus 300 may distinguish 2^{N} surface points of the object.

In operation 550, the geometry information obtaining apparatus 300 may obtain geometry information of the object using the 2^{N} surface points.

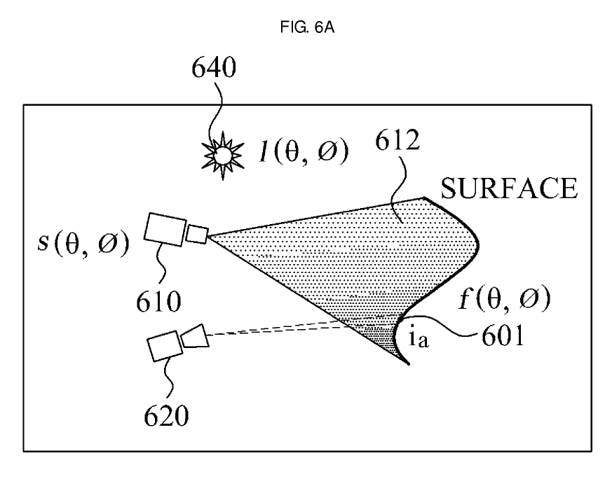

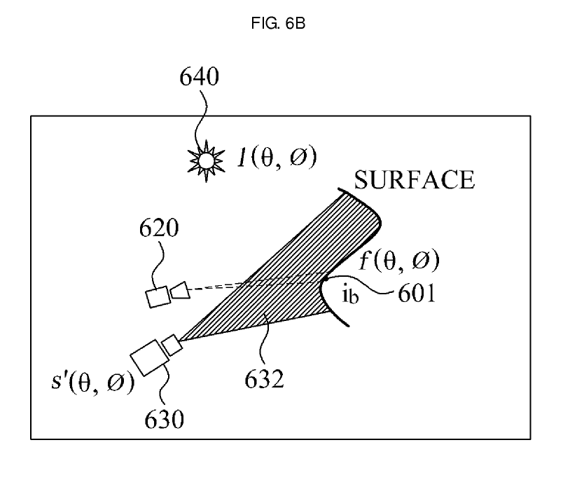

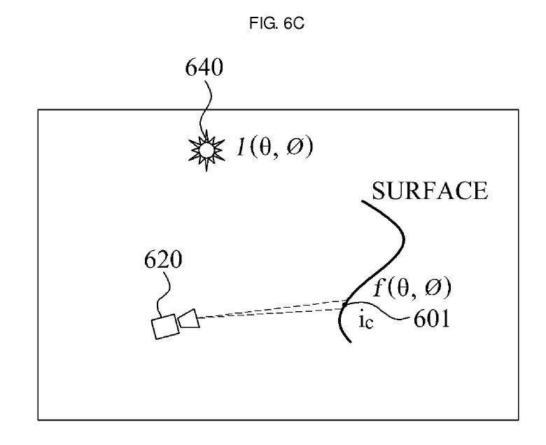

FIGS. 6A through 6C illustrate examples of obtaining material information and lighting information according to example embodiments.

Referring to FIGS. 6A through 6C, light emitting units 610 and 630, and camera unit 620 may be used to capture an image to obtain material information and lighting information.

The light emitting units 610 and 630 may include, for example, multi-spectral projectors. Additionally, the camera unit 620 may include, for example, a multi-spectral camera. In particular, the light emitting units 610 and 630 may include, for example, light emitting apparatuses that enable emitting of a light source for a plurality of frequency bands, and that include, for example, a light-emitting diode (LED), a liquid crystal display (LCD), an organic light-emitting diode (OLED), and the like.

FIG. 6A illustrates an example in which the light emitting unit 610 emits pattern lights 612 toward an object, and the camera unit 620 captures the object that receives the emitted pattern lights 612. In other words, the camera unit 620 captures the object upon which the pattern lights 612 have been emitted.

The light emitting unit 610 may divide a frequency band into N frequency bands, and may respectively assign the pattern lights 612 to the N frequency bands. The light emitting unit 610 may emit the pattern lights 612 to a surface 601 of the object, as shown in FIG. 6A. In this instance, the pattern lights 612 may be simultaneously emitted toward the object.

The camera unit 620 may capture an image of the object that receives the pattern lights 612. The camera unit 620 may receive lights that are reflected from the surface 610 of the object that receives the pattern lights 612.

FIG. 6B illustrates an example in which the light emitting unit 630 emits a straight light 632 to the surface 601 of the object, and the camera unit 620 captures an image of the object that receives the emitted straight light 632.

The light emitting unit 630 may assign the straight light 632 to a frequency band other than the frequency bands to which the pattern lights 612 of FIG. 6A have been assigned. The light emitting unit 630 may emit the straight light 632 to the surface 601, as shown in FIG. 6B.

The camera unit 620 may capture the image of the object that receives the straight light 632. The camera unit 620 may receive a light that is reflected from the surface 601 of the object that receives the straight light 632.

FIG. 6C illustrates an example in which the camera unit 620 captures the object in an environment in which only a natural light 640 exists.

The natural light 640 may refer to a predetermined lighting in a space in which an object and a camera exist, excluding lights emitted by the light emitting units 610 and 630.

When the light emitting units 610 and 630 are turned off, and when only the natural light 640 exists, the camera unit 620 may capture the object. Accordingly, the camera unit 620 may receive a reflected light that is reflected from the surface 601 of the object that receives the natural light 640.

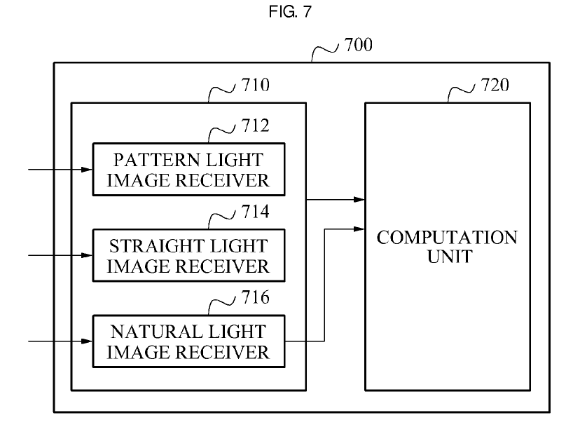

FIG. 7 illustrates a block diagram of an apparatus 700 for obtaining material information and lighting information according to example embodiments.

Referring to FIG. 7, the apparatus 700 may include an optical image receiving unit 710, and a computation unit 720.

The optical image receiving unit 710 may include a pattern light image receiver 712, a straight light image receiver 714, and a natural light image receiver 716.

The pattern light image receiver 712 may receive an image of an object that receives pattern lights that are respectively assigned to N frequency bands.

The straight light image receiver 714 may receive an image of an object that receives a straight light emitted from the light emitting unit 630. Specifically, the straight light may be assigned to a frequency band other than the N frequency bands received by the pattern light image receiver 712.

The natural light image receiver 716 may receive an image of an object that receives a natural light, in an environment in which only the natural light exists and a pattern light and straight light do not exist.

The received images may be associated with reflected lights that are reflected from surfaces of the objects that receive at least one of the pattern lights, the straight light, and the natural light.

The computation unit 720 may compute a material function, and a lighting function. Specifically, the computation unit 720 may compute at least one of a material function, an emitted lighting function, and a natural lighting function, based on the images received by the optical image receiving unit 710. Here, the material function may refer to a function associated with materials, and the lighting function may refer to a function associated with a lighting. Additionally, the emitted lighting function may refer to a function associated with an emitted lighting, and the natural lighting function may refer to a function associated with a natural lighting.

Pixel values of pixels of each of the received images may be expressed, as shown in the following Equations 1 through 3:

$$\begin{matrix}{i}_{a} = {∮}_{θ , φ} f ( θ , φ ) \{ s ( θ , φ ) + l ( θ , φ ) \} \partial θ \partial φ & [ Equation 1 ] \\ {i}_{b} = {∮}_{θ , φ} f ( θ , φ ) \{ {s}^{′} ( θ , φ ) + l ( θ , φ ) \} \partial θ \partial φ & [ Equation 2 ] \\ {i}_{c} = {∮}_{θ , φ} f ( θ , φ ) l ( θ , φ ) \partial θ \partial φ & [ Equation 3 ]\end{matrix}$$

In Equations 1 through 3, iₐ denotes a pixel value of an image of an object that receives a plurality of pattern lights, i_{b} denotes a pixel value of an image of an object that receives a straight light, and i_{c} denotes a pixel value of an image of an object that receives a natural light. Additionally, ƒ(θ,φ) denotes a material function, s(θ,φ) and s′(θ,φ) denote emitted lighting functions, and l(θ,φ) denotes a natural lighting function.

In Equations 1 through 3, functions ƒ(θ,φ) and l(θ,φ) are unknown.

First, the computation unit 720 may compute a material function using the following Equations 4 and 5:

$$\begin{matrix}{i}_{a} - {i}_{c} = {∮}_{θ , φ} f ( θ , φ ) s ( θ , φ ) \partial θ \partial φ & [ Equation 4 ] \\ {i}_{b} - {i}_{c} = {∮}_{θ , φ} f ( θ , φ ) {s}^{′} ( θ , φ ) \partial θ \partial φ & [ Equation 5 ]\end{matrix}$$

In Equations 4 and 5, iₐ denotes a pixel value of an image of an object that receives a plurality of pattern lights, i_{b} denotes a pixel value of an image of an object that receives a straight light, and i_{c} denotes a pixel value of an image of an object that receives a natural light. Additionally, ƒ(θ,φ) denotes a material function, s(θ,φ) and s′(θ,φ) denote emitted lighting functions, and l(θ,φ) denotes a natural lighting function.

The computation unit 720 may compute the function ƒ(θ,φ), using a difference between the pixel values iₐ and i_{c} in Equation 4, a difference between the pixel values i_{b} and i_{c} in Equation 5, and values of the functions s(θ,φ) and s′(θ,φ) that are already known.

The values of the functions s(θ,φ) and s′(θ,φ) may be adjusted by equipment during image capturing, and may be used to obtain an unknown value of the function ƒ(θ,φ).

The computation unit 720 may substitute the function ƒ(θ,φ) into Equation 3, to obtain the function l(θ,φ).

The above-described functions may be applied to various modeling schemes, and may be used as parameters.

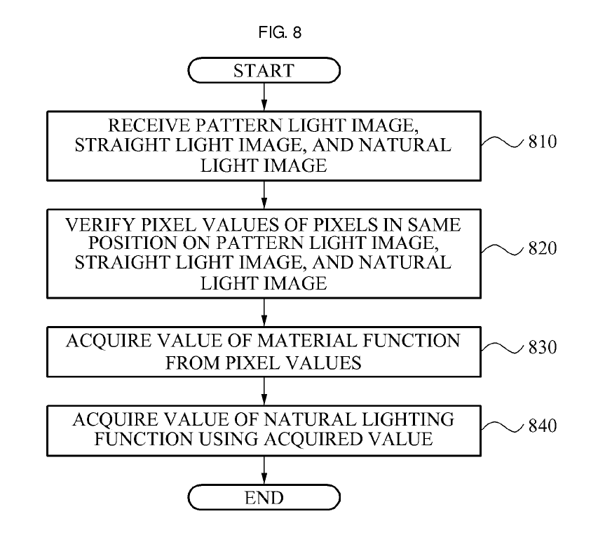

FIG. 8 illustrates a flowchart of a method of obtaining material information and lighting information according to example embodiments.

The method of FIG. 8 may be performed by the apparatus 700 of FIG. 7.

Referring to FIG. 8, in operation 810, the apparatus 700 may receive a pattern light image, a straight light image, and a natural light image.

In operation 820, the apparatus 700 may verify pixel values of pixels in the same position on the pattern light image, the straight light image, and the natural light image.

In operation 830, the apparatus 700 may acquire a value of a material function from the pixel values.

In operation 840, the apparatus 700 may acquire a value of a natural lighting function, using the value acquired in operation 830.

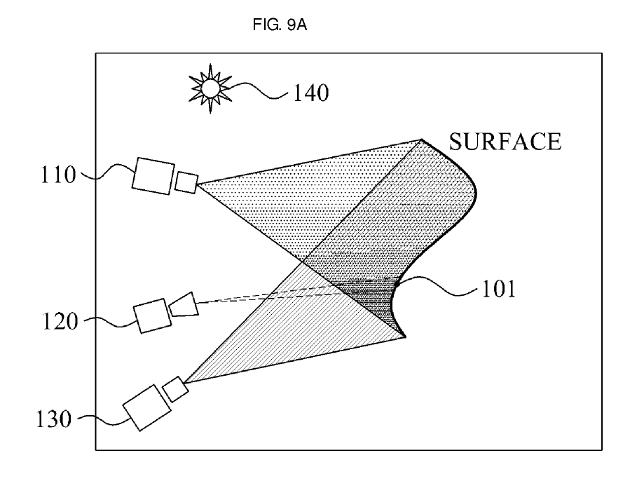

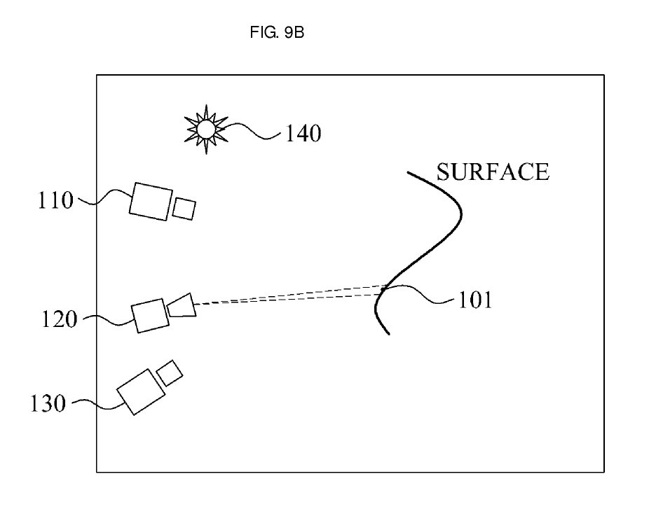

FIGS. 9A and 9B illustrate diagrams of an image capturing scheme according to example embodiments.

Referring to FIGS. 9A and 9B, image capturing of FIGS. 4 through 6C to obtain geometry information, material information, and lighting information of the object may be performed by minimizing a number of times for object capturing as shown in FIGS. 9A and 9B.

FIG. 9A illustrates an example in which a camera 120 captures an object that receives pattern lights and a straight light emitted from a first light emitting unit 110 and a second light emitting unit 130, when a natural light 140 exists.

FIG. 9B illustrates an example in which the camera 120 captures the object when only the natural light 140 exists, that is, when the first light emitting unit 110 and the second light emitting unit 130 are turned off.

To obtain geometry information, material information, and lighting information of the object, images may be acquired by capturing the object in the examples of FIGS. 9A and 9B. When an environment in which only the pattern lights and the straight light are emitted toward the object without a light condition of the natural light 140 is assumed, geometry information, material information, and lighting information may be obtained from the acquired images.

A geometry, a light condition, and material information of a single-view image captured in a predetermined light condition may be extracted. Thus, it is possible to mix, or combine a virtual object with an actual image by appropriately rendering the virtual object.

As described above, according to example embodiments, geometry information, lighting information, and material information of a single-view image captured in a predetermined light condition may be extracted, and thus it is possible to combine predetermined scenes in various views and lighting conditions.

Additionally, according to example embodiments, geometry information, lighting information, and material information of a single-view image captured in a predetermined light condition may be extracted, and thus it is possible to generate consecutive multi-view images with high image quality.

The method according to the above-described embodiments may be recorded in non-transitory computer-readable media or processor-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts.

Examples of computer-readable media or processor-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer or processor using an interpreter.

The described hardware devices may also be configured to act as one or more software modules or units in order to perform the operations of the above-described embodiments. The method of obtaining geometry information may be executed on a general purpose computer or processor or may be executed on a particular machine such as the apparatuses described herein. Any one or more of the software modules described herein may be executed by a dedicated processor unique to that unit or by a processor common to one or more of the modules.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. An apparatus for obtaining geometry information, the apparatus comprising:
a processor to control one or more processor-executable units;
an optical image receiving unit to receive an image of an object receiving a plurality of pattern lights;
a frequency verifying unit to verify, from the image, a plurality of frequency bands respectively corresponding to each of the plurality of pattern lights;
a code set assigning unit to assign a plurality of code values based on at least one reflected light corresponding to each of the plurality of frequency bands, the plurality of code values being used to distinguish surface points of the object; and
a surface point acquiring unit to distinguish the surface points of the object based on the plurality of code values.

2. The apparatus of claim 1, wherein the optical image receiving unit receives reflected lights corresponding to the plurality of pattern lights that are respectively assigned to each of the plurality of frequency bands.

3. The apparatus of claim 2, wherein the reflected lights are reflected from a surface of the object receiving the plurality of pattern lights.

4. The apparatus of claim 1, further comprising:
a geometry information extracting unit to obtain geometry information of the object using the surface points.

5. The apparatus of claim 1, wherein the code set assigning unit assigns a first code value to an area in which a light reflected from a surface of the object exists, and assigns a second code value to an area in which the reflected light does not exist, among the plurality of code values.

6. A system for obtaining geometry information, the system comprising:
a light emitting unit to emit a plurality of pattern lights to an object, each of the plurality of pattern lights being respectively assigned to one of a plurality of frequency bands;
a camera unit to capture the object receiving the pattern lights emitted from the light emitting unit; and
a geometry information obtaining unit to assign a plurality of code values based on at least one reflected light corresponding to each of the pattern lights, to distinguish surface points of the object based on the plurality of code values, and to obtain geometry information of the object using the surface points, the plurality of code values being used to distinguish the surface points.

7. An apparatus for obtaining material information and lighting information, the apparatus comprising:
a processor to control one or more processor-executable units;
an optical image receiving unit to receive an image of an object, the object receiving at least one of pattern lights, a straight light, and a natural light, the pattern lights being emitted from a first lighting emitting unit, and the straight light being emitted from a second lighting emitting unit; and
a computation unit to compute at least one of a material function, an emitted lighting function, and a natural lighting function, based on the image received by the optical image receiving unit.

8. The apparatus of claim 7, wherein the optical image receiving unit comprises:
a pattern light image receiver to receive an image of an object receiving a plurality of pattern lights;
a straight light image receiver to receive an image of an object receiving a straight light; and
a natural light image receiver to receive an image of an object receiving a natural light when the pattern lights and the straight light do not exist;

9. The apparatus of claim 7, wherein a pixel value iₐ of an image of an object that receives the plurality of pattern lights, a pixel value i_{b} of an image of an object that receives the straight light, and a pixel value i_{c} of an image of an object that receives the natural light are defined by the following equations:
$$\begin{matrix}{i}_{a} = {∮}_{θ , φ} f ( θ , φ ) \{ s ( θ , φ ) + l ( θ , φ ) \} \partial θ \partial φ , \\ {i}_{b} = {∮}_{θ , φ} f ( θ , φ ) \{ {s}^{′} ( θ , φ ) + l ( θ , φ ) \} \partial θ \partial φ , and \\ {i}_{c} = {∮}_{θ , φ} f ( θ , φ ) l ( θ , φ ) \partial θ \partial φ ,\end{matrix}$$
wherein ƒ(θ,φ) denotes a material function, s(θ,φ) and s′(θ,φ) denote emitted lighting functions, and l(θ,φ) denotes a natural lighting function.

10. The apparatus of claim 9, wherein the computation unit computes a material function, and emitted lighting functions, using the following equations:
$$\begin{matrix}{i}_{a} - {i}_{c} = {∮}_{θ , φ} f ( θ , φ ) s ( θ , φ ) \partial θ \partial φ , and \\ {i}_{b} - {i}_{c} = {∮}_{θ , φ} f ( θ , φ ) {s}^{′} ( θ , φ ) \partial θ \partial φ ,\end{matrix}$$
wherein iₐ denotes a pixel value of an image of an object that receives a plurality of pattern lights, i_{b} denotes a pixel value of an image of an object that receives a straight light, i_{c} denotes a pixel value of an image of an object that receives a natural light, ƒ(θ,φ) denotes a material function, s(θ,φ) and s′(θ,φ) denote emitted lighting functions, and l(θ,φ) denotes a natural lighting function.

11. The apparatus of claim 10, wherein the computation unit computes a natural lighting function, using the computed material function, the computed emitted lighting functions, and the following equation:
$${i}_{c} = {∮}_{θ , φ} f ( θ , φ ) l ( θ , φ ) \partial θ \partial φ ,$$
wherein i_{c} denotes a pixel value of an image of an object that receives a natural light, ƒ(θ,φ) denotes a material function, s(θ,φ) and s′(θ,φ) denote emitted lighting functions, and l(θ,φ) denotes a natural lighting function.

12. A system for obtaining material information and lighting information, the system comprising:
a first light emitting unit to emit a plurality of pattern lights to an object, the plurality of pattern lights being respectively assigned to a plurality of frequency bands;
a second light emitting unit to emit a straight light to the object, the straight light being assigned to a frequency band other than the plurality of frequency bands;
a camera unit to capture an image of the object receiving lights emitted from the first light emitting unit and the second light emitting unit, or to capture an image of the object receiving a natural light other than the lights emitted from the first light emitting unit and the second light emitting unit; and
a computation unit to compute at least one of a material function, emitted lighting functions, and a natural lighting function, based on the captured images.

13. A method of obtaining geometry information, the method comprising:
receiving an image of an object receiving a plurality of pattern lights;
verifying, from the image, a plurality of frequency bands respectively corresponding to each of the plurality of pattern lights;
assigning, by way of a processor, a plurality of code values based on at least one reflected light corresponding to each of the plurality of frequency bands, the plurality of code values being used to distinguish surface points of the object; and
distinguishing the surface points of the object based on the plurality of code values.

14. The method of claim 13, wherein the image is associated with reflected lights corresponding to the plurality of pattern lights emitted toward the object and reflected from a surface of the object.

15. The method of claim 13, further comprising obtaining geometry information of the object using the surface points.

16. The method of claim 13, wherein the assigning comprises:
assigning a first code value to an area in which a light reflected from a surface of the object exists; and
assigning a second code value to an area in which the reflected light does not exist, among the plurality of code values.

17. A non-transitory computer-readable storage medium storing computer readable code comprising a program for implementing the method of claim 13.

18. A method of obtaining material information and lighting information, the method comprising:
receiving an image of an object, the Object receiving at least one of pattern lights, a straight light, and a natural light, the pattern lights being emitted from a first lighting emitting unit, and the straight light being emitted from a second lighting emitting unit; and
computing, by way of a processor, at least one of a material function, an emitted lighting function, and a natural lighting function, based on the received image.

19. The method of claim 18, wherein a pixel value iₐ of an image of an object that receives the plurality of pattern lights, a pixel value i_{b} of an image of an object that receives the straight light, and a pixel value i_{c} of an image of an object that receives the natural light are defined by the following equations:
$$\begin{matrix}{i}_{a} = {∮}_{θ , φ} f ( θ , φ ) \{ s ( θ , φ ) + l ( θ , φ ) \} \partial θ \partial φ , \\ {i}_{b} = {∮}_{θ , φ} f ( θ , φ ) \{ {s}^{′} ( θ , φ ) + l ( θ , φ ) \} \partial θ \partial φ , and \\ {i}_{c} = {∮}_{θ , φ} f ( θ , φ ) l ( θ , φ ) \partial θ \partial φ ,\end{matrix}$$
wherein ƒ(θ,φ) denotes a material function, s(θ,φ) and s′(θ,φ) denote emitted lighting functions, and l(θ,φ) denotes a natural lighting function.

20. The method of claim 19, wherein the computing comprises:
computing the functions (θ,φ) and s′(θ,φ), using a difference between the pixel values iₐ and i_{c}, and a difference between the pixel values i_{b} and i_{c}; and
computing the function ƒ(θ,φ), using the computed functions s(θ,φ) and s′(θ,φ).

21. The method of claim 19, wherein the computing comprises:
computing the functions s(θ,φ) and s′(θ,φ), a difference between the pixel values iₐ and i_{c}, and a difference between the pixel values i_{b} and i_{c};
computing the function ƒ(θ,φ), using the computed functions s(θ,φ) and s′(θ,φ); and
computing the function l(θ,φ), using the computed function ƒ(θ,φ), and the following equation:
$${i}_{c} = {∮}_{θ , φ} f ( θ , φ ) l ( θ , φ ) \partial θ \partial φ ,$$
wherein i_{c} denotes a pixel value of an image of an object that receives a natural light, ƒ(θ,φ) denotes a material function, s(θ,φ) and s′(θ,φ) denote emitted lighting functions, and l(θ,φ) denotes a natural lighting function.

22. A non-transitory computer-readable storage medium storing computer readable code comprising a program for implementing the method of claim 18.

23. A method of obtaining material information, the method comprising:
receiving an image of an object, the object receiving at least one of pattern lights, a straight light, and a natural light, the pattern lights being emitted from a first lighting emitting unit, and the straight light being emitted from a second lighting emitting unit; and
computing, by way of a processor, a material function, using pixel values of pixels of the received image, the pixel values being defined by a material function, an emitted lighting function, and a natural lighting function,
wherein the computing comprises:
computing emitted lighting functions, using a difference between a pixel value iₐ of an image of an object that receives a plurality of pattern lights and a pixel value l_{c} of an image of an object that receives a natural light, and a difference between the pixel value i_{c} and a pixel value i_{b} of an image of an object that receives a straight light; and
computing the material function, using the computed emitted lighting functions.

24. A non-transitory computer-readable storage medium storing computer readable code comprising a program for implementing the method of claim 23.

25. A method of obtaining lighting information, the method comprising:
receiving an image of an object, the object receiving at least one of pattern lights, a straight light, and a natural light, the pattern lights being emitted from a first lighting emitting unit, and the straight light being emitted from a second lighting emitting unit; and
computing, by way of a processor, a lighting function, using pixel values of pixels of the received image, the pixel values being defined by a material function, an emitted lighting function, and a natural lighting function,
wherein the computing comprises:
computing emitted lighting functions, using a difference between a pixel value iₐ of an image of an object that receives a plurality of pattern lights and a pixel value i_{c} of an image of an object that receives a natural light, and a difference between the pixel value i_{c} and a pixel value i_{b} of an image of an object that receives a straight light;
computing a material function, using the computed emitted lighting functions; and
computing a natural lighting function, using the material function, and the following equation:
$${i}_{c} = {∮}_{θ , φ} f ( θ , φ ) l ( θ , φ ) \partial θ \partial φ ,$$
wherein i_{c} denotes a pixel value of an image of an object that receives a natural light, ƒ(θ,φ) denotes a material function, s(θ,φ) and s′(θ,φ) denote emitted lighting functions, and l(θ,φ) denotes a natural lighting function.

26. A non-transitory computer-readable storage medium storing computer readable code comprising a program for implementing the method of claim 25.

27. An apparatus obtaining geometry information, the apparatus comprising:
a processor to control one or more processor-executable units;
an optical image receiving unit to receive an image of an object illuminated by a plurality of pattern lights emitted by a plurality of light emitting units;
a frequency verifying unit to verify, from the image, a plurality of frequency bands respectively corresponding to each of the plurality of pattern lights; and
a code set assigning unit to assign a plurality of code values based on at least one reflected light corresponding to each of the plurality of frequency bands, the plurality of code values being used to distinguish surface points of the object.

28. A method of obtaining geometry information, the method comprising:
receiving an image of an object illuminated by a plurality of pattern lights, wherein a different pattern light is respectively assigned to each of a plurality frequency bands;
verifying, from the image, the pattern lights respectively assigned to the frequency bands and classifying the frequency bands based on the pattern lights; and
assigning, by way of a processor, a plurality of code values based on at least one reflected light corresponding to each of the plurality of frequency bands, the plurality of code values being used to distinguish surface points of the object.

29. A non-transitory computer-readable storage medium storing computer readable code comprising a program for implementing the method of claim 28.
